(19) United States
(12) Patent Application Publication
(10) Pub. No.: US 2014/0369538 A1
(43) Pub. Date: Dec. 18, 2014

(54) Assistive Listening System

(71) Applicant: Parametric Sound Corporation, Poway, CA (US)

(72) Inventors: Elwood G. Norris, Poway, CA (US); John Bolton, Poway, CA (US)

(21) Appl. No.: 13/917,273

(22) Filed: Jun. 13, 2013

(51) Int. Cl. H04R 25/00

(52) U.S. Cl. CPC H04R 25/558
USPC 381/315

(57) ABSTRACT

The present disclosure describes methods and systems that can allow a digital signal processor (DSP) in an ultrasonic audio system to be adjusted according to a listener's preferences. In one embodiment, the listener or user can attempt to configure a DSP through a plurality of user interfaces. In another embodiment, the listener can provide an audiogram, previously generated by an audiologist, and send said audiogram to the manufacturer in order to adjust the DSP in the ultrasonic sound system to his/her hearing preferences.

### RELATED APPLICATIONS

This application is related to U.S. patent application Ser. No. 13/789,491, which is hereby incorporated herein by reference in its entirety.

### BACKGROUND

1. Field of the Disclosure

The present disclosure relates generally to ultrasonic sound systems. More particularly, some embodiments relate to ultrasonic sound systems and methods for hearing aids, assisted listening devices and other audio applications.

2. Background

Hearing aids are generally well-known in the art and in widespread use. In a typical hearing aid, a microphone can be used to pick up sound waves and convert that information into electrical signals. An audio amplifier may magnify the electrical signals within the frequencies of interest (500 Hz to 8 KHz), and then may send the amplified signals to a speaker located at the inner portion of the hearing aid. The speaker can convert the electrical signals back into sound waves.

Many conventional hearing aids are relatively large devices that are quite visible to other persons. A recent trend has been to make the hearing aid as small as possible, and to place a portion of it inside the ear where it is not visible. There are several patents which disclose hearing aids that ostensibly fit within the external auditory canal. It must be noted that, even in such patented inventions disclosing “in-the-canal” hearing aids, a portion of the hearing aid may be visible and noticeable to other persons because the speaker and the electronics are too large to fit within the external auditory canal. One exception is disclosed in U.S. Pat. No. 4,817,609 by Perkins, wherein the external auditory canal can be surgically enlarged so that the disclosed hearing aid can fit deep inside the canal, thereby showing very little to outside observers. Such surgery is an extraordinary remedy that most human users would wish to avoid if a more satisfactory hearing aid were available.

### SUMMARY

Embodiments of the systems and methods described in the present disclosure provide an ultrasonic audio system for a variety of different applications, According to one embodiment, an ultrasonic sound system can include a signal source, a processor, a digital signal processor (DSP), amplifier, and emitters. The DSP can also include a local oscillator to generate the ultrasonic carrier signal, and a multiplier to multiply the audio signal by the carrier signal.

According to another embodiment, systems and methods described herein can allow an ultrasonic audio system to be configured or pre-configured according to a response profile of a listener.

In one embodiment, an audiologist can generate an audiogram, which can be programmed into the system. Said audiogram can include the listener's hearing loss information, showing the frequencies where the listener can and cannot hear. Based on the audiogram information, the DSP in the ultrasonic audio system can be adjusted to comply with the listener's hearing deficiencies.

In yet another embodiment, the listener or user can use a plurality of user interfaces to communicate with the DSP in the ultrasonic audio system. In other words, the user can be able to adjust parameters such as frequency response, equalization, compression, and volume so as to boost the signals when the user has difficulty in hearing. Within user interfaces, the user or listener can use a remote control via Bluetooth; a phone application having a preloaded hearing aid application; or a PC application connected to the DSP via any communication protocol such as Ethernet, Serial, USB or Wireless. Furthermore, a user who can be of ordinary skill in the art, can manually control the DSP to directly adjust settings to its own preferences.

The disclosed embodiments of a customizable DSP in an ultrasonic audio system can provide advantages for the hearing impaired or any user with hearing deficiencies. One of the advantages can be that the sound is directed to the listener's head, therefore the user does not need to wear any device in the ear, hence no need for batteries. Another advantage can be that the ultrasonic audio system is not only programmed for one but for multiple listeners. In other words, a plurality of users can have their own preset programmed in the DSP according to their hearing preferences. Additional features and advantages can become apparent from the detailed descriptions which follow, taken in conjunction with the accompanying drawings.

### BRIEF DESCRIPTION OF THE DRAWINGS

Embodiments of the present disclosure are described by way of example with reference to the accompanying figures, which are schematic and are not intended to be drawn to scale. Unless indicated as representing prior art, the figures represent aspects of the present disclosure.

FIG. 1 is a block diagram generally representing the features of the mammalian ear.

FIG. 2 is a schematic view lustrating an example of a conventional audio sound system.

FIG. 3 is a schematic view depicting an ultrasonic sound system that can be used with the methods and systems described in the present disclosure.

FIG. 4 is a block diagram depicting a customizable ultrasonic audio system, according to various embodiments.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of the present disclosure.

### Definitions

As used herein, “emitter” may refer to any device capable of emitting ultrasonic signals.

As used herein, “transducer” may refer to a device that converts audio acoustic signals to electrical signals, and vice versa.

As used herein, “ultrasonic signals” in communication systems may be used as carrier-signals in the production of audio acoustic signals.

As used herein, “audio acoustic signals” may refer to airborne sound pressure waves having frequencies within the bandwidth detectable by the human ear.

As used herein, “equalization” may refer to the process of adjusting the balance between frequency components within an electronic signal. The circuit or equipment which may be used to achieve equalization can be called an equalizer. The equalizer may either strengthen (boost) or weak (cut) the energy of specific frequency bands.

### Description

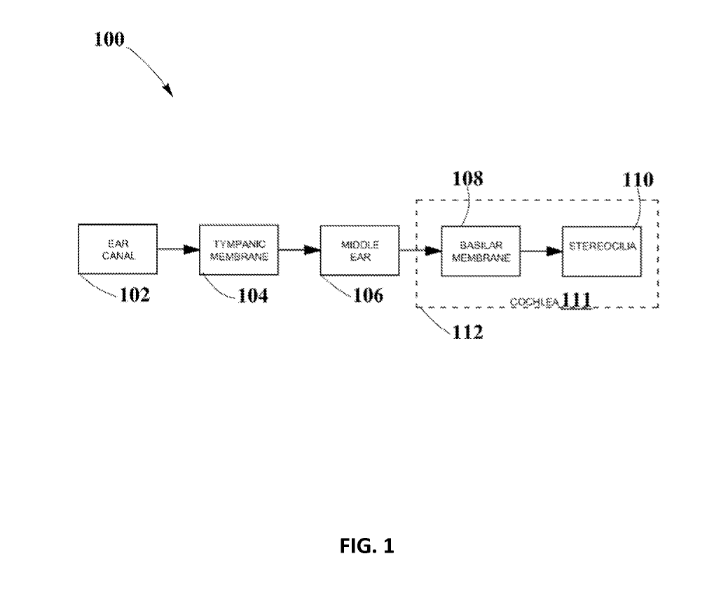

FIG. 1 is a block diagram generally representing the features of the mammalian ear. Sounds detected by a human subject reach the ear 100, travel through the external auditory meatus, ear canal 102, to the inner ear 112. The sound wave in the ear canal 102 causes vibration in the tympanic membrane 104, or ear drum. The vibration is conveyed through the middle ear 106 by way of three small bones commonly referred to as the hammer, anvil and stirrup. The tympanic membrane 104 and the three small bones, or ossicles, carry the sound from the outer ear 100, through the middle ear 106 to the inner ear 112. Inner ear 112 includes a spiral-shaped cochlea 111, which is filled with a fluid that vibrates in response to vibrations of the ossicles. Particularly, vibrations of the stirrup cause corresponding pressure changes in the fluid of inner ear 112. Therefore, motion of the stapes is converted into motion of the fluids of cochlea 111, which some theorize results in a traveling wave moving along basilar membrane 108.

These pressure changes result in oscillating movements of tiny hair cells, or stereocilia 110, in the inner ear 112. More particularly, vibrations of the basilar membrane 108 move the bodies of the hair cells (stereocilia 110), deflecting them in a sheering motion, transforming the mechanical energy of sound waves into electrical signals, ultimately leading to an excitation of the auditory nerve. Accordingly, cochlea 111 converts the mechanical energy of the stapes into electrical impulses. These impulses are transmitted via the central auditory nervous system to the auditory processing centers of the brain.

Different sounds are believed to excite different hair cells at different points along what is known as the basilar membrane 108. The basilar membrane 108 has cross striations, and it varies in width from the base to the apex of the cochlea 111. Accordingly, different portions of the basilar membrane 108 vibrate at different frequencies. This, in turn, causes different sound frequencies to affect different groupings of the hair cells.

Some audible sound can also reach the inner ear 112 through bone conduction. However, it has been shown that sound conduction through the outer and middle ear 106 is the dominant mechanism for allowing audible sound waves to reach the inner ear 112, and that creating waves with sufficient energy to carry audio information to the inner ear 112 requires inducement by direct mechanical vibration. Accordingly, sound waves arriving at the listener are predominantly captured by the outer ear and delivered through the hearing system to the inner ear 112. Sound waves in the range of 20-20,000 Hz are typically only heard through bone conduction when the sound has very high intensity and the listener's ear canals are blocked or audio is otherwise prevented from traveling through the outer and middle ear 106.

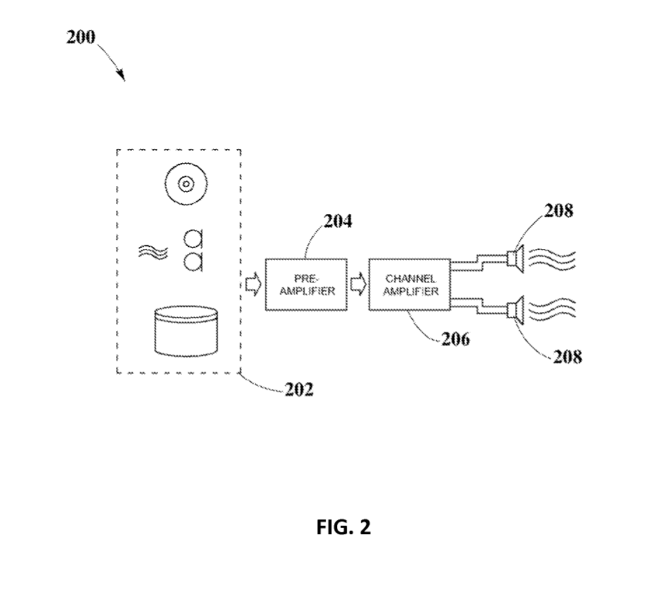

FIG. 2 is a schematic view illustrating an example of a conventional audio sound system 200. In a conventional audio sound system 200, audio content from a signal source 202, such as, for example, a microphone or microphones, memory, a data storage device, streaming media source, i.e., CD, DVD, TV set or other audio source can be received. The audio content can be decoded and converted fro digital to analog form in a pre-amplifier 204, depending on the source. Pre-amplifier 204 can control volume levels, equalization, and source selection among others. The audio content can then be amplified by an amplifier 206 and played to the listener or listeners over conventional loudspeakers 208. The audio can be delivered to the listener(s) in the form of sound waves, which can be detectable by human ears.

### Ultrasonic Sound System

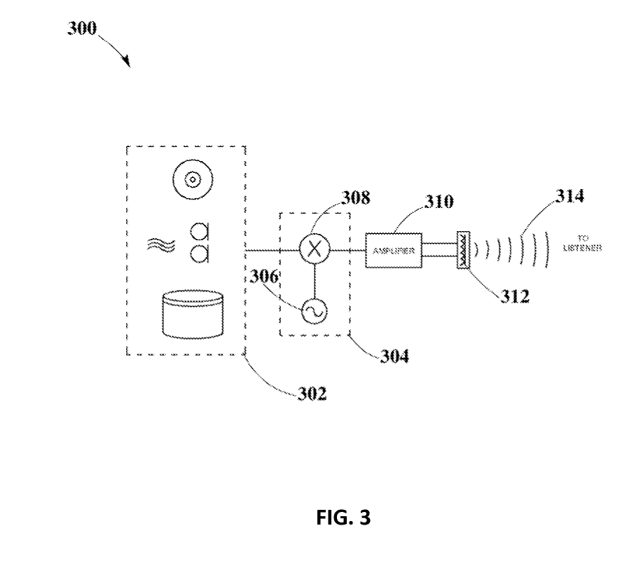

FIG. 3 is a schematic view depicting an ultrasonic sound system 300 that can be used with the methods and systems described in the present disclosure.

In FIG. 3, audio content from a signal source 302, received by ultrasonic sound system 300, is modulated onto an ultrasonic carrier of a predetermined frequency, at DSP 304. The DSP 304 typically includes a local oscillator 306 to generate the ultrasonic carrier signal and a multiplier 308 to multiply the audio signal by the carrier signal. An amplifier 310 can then be used to amplify the resultant signal which can be an ultrasonic wave 314 with a carrier frequency. In some embodiments, ultrasonic wave 314 can be a parametric ultrasonic wave. In most cases, the modulation scheme used is similar to amplitude modulation, or AM. AM can be achieved by multiplying the ultrasonic carrier by the information-carrying signal, which in this case is the audio signal. The spectrum of the modulated signal can have two sidebands, an upper and a lower side band, which are symmetric with respect to the carrier frequency, and the carrier itself. In other embodiments, single sideband using upper sideband is preferred.

The modulated ultrasonic signal is then provided to emitter 312, which launches ultrasonic wave 314 into the air. When played back through emitter 312 at a sufficiently high sound pressure level, due to the nonlinear behavior of the air through which it is “played” or transmitted, the carrier in the signal mixes with the sideband(s) to demodulate the signal and reproduce the audio content. This is sometimes referred to as self-demodulation. Thus, even for single-sideband implementations, the carrier is included with the launch signal so that self-demodulation can take place. Although the system illustrated in FIG. 3 uses a single transducer to launch a single channel of audio content, one of ordinary skill in the art after reading this description can readily understand how multiple mixers, amplifiers and transducers can be used to transmit multiple channels of audio using the present technology.

Alternatively, in some embodiments rather than launching the ultrasonic signal into the air toward the listener, an ultrasonic transducer or other actuator can be positioned percutaneously or subcutaneously at the user's skull to induce the vibrations of the modulated ultrasonic carrier and sideband(s) directly to the listener's skull. Accordingly, in this and other applications, the ultrasonic system can be configured as a portable system to be worn or carried by the user.

In some embodiments, the audio system can replace or augment the conventional creation of electrical signals stimulated by vibration of the tympanic membrane. Particularly, in some embodiments, an ultrasonic audio system such as the one shown in FIG. 3 can be configured to result in creation of the sound wave in or near the inner ear to enhance the creation of electrical signals that excite the auditory nerve.

The auricle, or pinna, is the visible portion of the human ear that can be seen protruding from the temporal lobe. It is made up primarily of skin and cartilage. The auricles collect sound and concentrate it at the eardrum. The auricles also assist the listener in localizing sound and determining from which direction the sound is originating. Once through the auricle, conventional sound waves enter the ear through the external auditory meatus, which is commonly referred to as the ear canal The external auditory meatus is roughly cylindrical in shape, and directs sound to the tympanic membrane.

The structure of the external auditory meatus creates resonance at certain frequencies, resulting in the generation of standing waves.

### Customizable DSP in Ultrasonic Sound System.

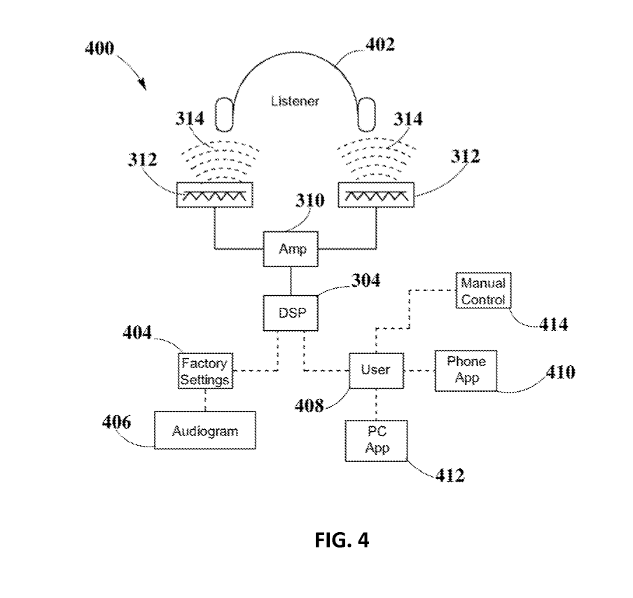

FIG. 4 is a block diagram of a customizable DSP 304 in an ultrasonic sound system 400 that can be configured by a user or pre-configured with factory settings to emit parametric ultrasonic waves directed to the listener's head, according to various embodiments. The DSP can include, or can be in communication with, a hearing profile module that can receive and process a hearing profile unique to a user. The hearing profile module can be functionally incorporated into the DSP in a number of manners which would be apparent to one of ordinary skill in the art having possession of this disclosure.

In one embodiment, an ultrasonic sound system 400 typically includes DSP 304, amplifier 310, and emitters 312. Ultrasonic sound system 400 can follow the process described in HG. 3 where audio content from a signal source 302 is received at DSP 304, modulated onto an ultrasonic signal and sent to emitters 312, via an amplifier 310, to generate ultrasonic waves 314.

In another embodiment, DSP 304 can be customizable. Ultrasonic sound system 400 can be pre-configured by adjusting DSP 304 at factory settings 404. A listener 402 can provide the manufacturer of the ultrasonic sound system 800 an audiogram or hearing profile 406, previously generated by an audiologist. Said audiogram 406 can include the listener's 402 hearing loss information, showing the listener's 402 frequency response. Based on the audiogram 406 information, DSP 304 can be adjusted to comply with the listener's 402 hearing deficiencies. In other words, based on the tones the listener cannot hear, frequency response, equalization (EQ), compression, and volume can be adjusted to boost the tones or signals where the listener shows difficulty in hearing. As a result, a pre-configured DSP 304 for an ultrasonic sound system 400 can be produced.

According to another embodiment, DSP 304 in ultrasonic sound system 400 can be configured by user 408. In this embodiment, user 408 can configure the DSP 304 through a plurality of user interfaces (UI). The user 408 can adjust the DSP 304 via a phone app 410. Phone app 410 can contain a preloaded audio test which can play a plurality of different tones. The tones played by phone app 410 can or cannot be heard by user 408. The feedback from user 408 can be used to create a profile that is unique for user 408. As a result, phone app 410 can communicate via any communication protocol and send the profile to DSP 304.

User 408 can also employ a PC App 412 connected via Ethernet, serial cable, USB or any hardware interface to communicate with DSP 304. PC App 412 may contain a preloaded audio test which can play a plurality of different tones. The tones played by PC App 412 may or may not be audible by user 408. The feedback of user 408 can be used to create a profile that is unique for user 408. As a result, PC App 412 can communicate and send this preset or profile to DSP 304.

Finally, user 408, who can be one of ordinary skill in the art, can manually control 414 DSP 304 either directly on the assisted listening device, though the phone application, or through an application on the personal computing device application in order to adjust EQ, frequency response, compression, and volume, according to listener's 402 hearing deficiencies.

1) An assistive listening device, comprising:
a digital signal processor (“DSP”);
a signal source operatively coupled to the DSP;
an amplifier operatively coupled to the DSP;
at least one ultrasonic emitter operatively coupled to the DSP;
a hearing profile module, operatively coupled to the DSP, the hearing profile module and the DSP being cooperatively capable of receiving a unique hearing profile reflecting a user's range of hearing to thereby determine which frequencies the user has difficulty hearing, and are capable of adjusting an outgoing frequency response, equalization, compression, and/or volume so as to enable hearing by the user of frequencies indicated by the hearing profile as problematic;
a remote computing device containing the user's unique hearing profile; and
a communication module in communication with the remote computing device and the hearing profile module; wherein
the remote computing device i) allows the user to load the personalized hearing profile through the communication module to the hearing profile module to thereby adjust the settings of the assisted listening device according to the personalized hearing profile, and ii) allows the user to manually configure the DSP to optimize the assisted listening device for the user's hearing deficiencies.

2) (canceled)

3) (canceled)

4) The device of claim 1, wherein the remote computing device includes a personal computer.

5) The device of claim 1, wherein the remote computing device includes a smart phone.

6) A method of providing hearing assistance to a hearing impaired person, comprising:
obtaining a unique hearing profile reflecting ranges of frequencies for which a user has hearing deficiencies;
providing an assisted listening device having at least one ultrasonic emitter, an amplifier, a digital signal processor (“DSP”) and a signal source;
loading the unique hearing profile onto the DSP; and
based on the unique hearing profile, adjusting one or more sound characteristics of sounds falling within the ranges of frequencies in which the user has hearing deficiencies to boost the frequencies in order to aid the user's ability to hear sounds falling in said ranges of frequencies; and
allowing the user to manually adjust one or more of: a frequency response, an equalization, a compression, or an amplitude of a volume, according to the user's hearing deficiencies.

7) The method of claim 6, further comprising:
storing the unique hearing profile on a remote computing device; and
providing a communication protocol that enables a user to communicate the unique hearing profile to the assisted listening device.

8) The method of claim 7, wherein the unique hearing profile is manually configurable by the user via the remote computing device.

9) The method of claim 8, wherein the remote computing device includes a smart phone.

10) The method of claim 8, wherein the remote computing device includes a personal computing device.

11) The method of claim 6, wherein the one or more sound characteristics include frequency response.

12) The method of claim 6, wherein the one or more sound characteristics include compression.

13) The method of claim 6, wherein the one or more sound characteristics include equalization.

14) The method of claim 6, wherein the one or more sound characteristics include volume.

15) The method of claim 9, wherein the unique hearing profile is generated by the remote computing device based upon a series of tones generated by the remote computing device.

16) The method of claim 15, wherein the unique hearing profile is generated by a smart phone based upon a series of tones generated by the smart phone.

17) The method of claim 15, wherein the unique hearing profile is generated by a personal computer based upon a series of tones generated by the personal computer.

18) (canceled)
